(19) United States
(12) Patent Application Publication
(10) Pub. No.: US 2011/0303433 A1
(43) Pub. Date: Dec. 15, 2011

(54) GFI AND SWITCH PLATE UTILITY HANGER FOR KEYS, BLOW DRYER AND CURLING IRONS

(76) Inventor: Michael Phillip Wagner, Newark, DE (US)

(21) Appl. No.: 12/789,009

(22) Filed: Jun. 11, 2010

(51) Int. Cl. H02G 3/14

(52) U.S. Cl. 174/66

(57) ABSTRACT

A balanced coverplate for an electrical or communication junction box including an upper portion and a substantially aligned lower portion for storage of items on holding means such as hooks, pegs or magnets. The upper portion of the coverplate may conveniently supplant a standard wall outlet/receptacle cover plate or switch cover plate. The lower portion is primarily intended for storage of items and extends from the lower edge of the upper portion. A main portion plate of the lower portion is intended to guard the wall from contact with the items being stored. The upper and lower portions are substantially aligned with the fasteners captured by the junction box, so torque about each fastener is substantially minimized, thus ensuring the longevity of the fasteners and their respective apertures of the junction box while protecting the wall surface below the outlet and/or switch.

### CROSS REFERENCES TO RELATED APPLICATIONS

NONE

### BACKGROUND OF THE INVENTION

### Field of the Invention

This invention relates in general to switch-plate storage devices and more particularly to a storage devices mechanically associated with coverplates or their equivalents. Switch plates and other cover plates are typically used to cover an electrical junction box, typically used to splice electrical and communication lines by means of splices, wire-nuts and electrical terminals. Cover plates are typically used to substantially cover junction boxes either surface mounted to wall studs, headers, drywall, paneling. Cover plates are typically required by building electrical codes for protecting an occupant from splices and exposed power wire conductors. Junction boxes are typically made of a plastic, polymer, or metal.

Accessible storage of personal items such as personal electric appliances (hair dryers, personal appliances, curling irons, hair irons, hair brushes, combs, electric razors, hair clippers, etc.) are commonly necessitated in domestic and commercial housing (hotels, motels, rental units, apartments, housing) and commercial enterprises (barber shops, hair salons, locker rooms, dormitories, etc.). Typically drawers or shelving, bins and even magnets, hooks and pegs are presented for storage solutions, for storing appliances in a convenient manner. A more convenient storage solution for electrical personal appliances are hooks, pegs or magnets, associated with the wall outlet, switch or receptacle from which the appliance would draw its power or signal. The solution of this invention necessitates only the replacement of the existing cover-plate of the previously installed junction box.

Prior art cover plate and hook assemblies are typically laterally disposed, thus imposing a torque on the fasteners used to secure the switch or receptacle cover plate to the junction box. Over time, and use of the hooks, the force applied to the hook by the user placing and retrieving an item (such as a hair dryer) from the hook imposed a torque force on the screws holding the cover plate portion on the junction box, thus weakening the hold of the screws on the junction box, and in some cases damaging the screws and or the screw holes in the junction box beyond repair. Replacement of the junction box would be necessitated if the cover plate was not able to be fastened properly w.r.t. electrical building codes. Replacement of the junction box would require removal of the switch or duplex plug, removal of the damaged junction box, re-insertion of the wires into the new junction box, affixing an “old construction” junction box to the hole in the wall/drywall, securing of the existing wiring to the switch/outlet, affixing the switch/outlet to the newly replaced “old construction” junction box, and re-fitting or re-placing of the cover plate. A licensed electrian would normally charge from $50 to $125 per box for this work, assuming the existing wiring does not become damaged or shortened during replacement. Lets hope the electrician doesn't damage your drywall, wallpaper, paneling or tile work while performing these duties. That just may lead to another project and greater expense.

### SUMMARY OF THE INVENTION

The instant invention provides improvements in wall mounted junction boxes and associated storage device which is easily installed and removed and conveniently located. In a preferred embodiment, the storage device coverplate is installed by removing screws securing an existing coverplate and replacing with the current invention screwing by using the existing screws or replacement screws which may aesthetically match the new coverplate.

In one embodiment the instant invention comprises a storage device applied as a cover plate, comprising an upper portion capable of being affixed to a junction box, the upper portion comprising at least one cover plate; wherein the upper portion is capable of hosting an utility aperture; the at least one cover plate having at least one affixing aperture for accepting a fastener for fastening to the junction box; a lower portion, integrally formed with the upper portion, being significantly weight balanced with respect to the fastener means of the upper portion so as to impose no net torque upon the fastener means when the upper portion is affixed to the junction box; the lower portion further comprising a storage means for storage of an item; the lower portion protecting a wall surface from the stored item; the upper portion and the lower portion being of monolithic construction; the monolithic construction being formed of primarily recycled materials and/or recyclable materials.

Wherein the aperture comprises an aperture for accepting a switch arm, GFCI outlet, 15A outlet, 20A, 110V outlet, 220V outlet, 12V outlet, rocker switch, dimmer switch, co-ax outlet, Ether-net outlet, telephone outlet, the gang upper portion comprises at least one aperture.

In another embodiment the instant invention comprises a storage device applied as a cover plate further comprising wherein the upper portion comprises at two or more cover areas each for significantly covering at least one bay of the junction box comprising at least one of a single gang module and a multiple gang module.

In another embodiment of the instant the lower portion is significantly as wide as the upper portion or significantly wider.

In another embodiment of the instant invention the upper portion comprises at least one cover area for accepting at least one of: a toggle switch arm of a switch installed within a gang of the junction box; a single power outlet installed within a gang of the junction box, a double power outlet installed within a gang of the junction box; a duplex power outlet installed within a gang of the junction box, a double power outlet installed within a gang of the junction box; a GFI power outlet installed within a gang of the junction box, a double power outlet installed within a gang of the junction box; a blank cover; a dimmer switch rheostat arm installed within a gang of the junction box; a coaxial outlet installed within a gang of the junction box; a telephone jack array installed within a gang of the junction box; a split audio/video outlet installed within a gang of the junction box; an Ethernet outlet installed within a gang of the junction box; a deco switch installed within a gang of the junction box.

In another embodiment of the instant invention the upper portion comprising at least two of the cover areas, so as to significantly cover a multiple gang junction box.

In another embodiment the instant invention comprises recycled material and the recyclable material is selected from: virgin materials, metals, alloys, steel, stainless steel, brass, bronze, copper, aluminum, nickel, zinc, pewter, platinum, gold, gold plate, plastics, plastic materials, polycarbonate, resin, epoxy, nylon, polyethylene, high-density polyethylene (HDPE), low-density polyethylene (LDPE), medium density polyethylene (MDPE), linear low-density polyethylene (LLDPE), polyethylene terephthalate (PET), ppolyvinyl chloride (PVD) vinyl, PET types: Polyethylene Terephthalate (PET, PETE), Ultra-high-molecular-weight polyethylene (UHMWP), High Density Polyethylene (HDPE), Polyvinyl Chloride (PVC), Low Density Polyethylene (LDPE), Polypropylene (PP), Polystyrene (PS), polycarbonate or ABS, other plastics, any other recycled or recyclable polymer.

In another embodiment of the instant invention the lower portion comprising the storage means for storage of the item; wherein the storage means comprises at least one array of hooks or pegs; wherein the array is significantly centered with respect to the averaged location of the at least one affixing aperture for accepting the fastener for fastening to the junction box, so as to impose no net torque on the fastener or fasteners.

In another embodiment of the instant invention the cover plate is manufactured with recycled materials and wherein the cover plate is later recycled.

In another embodiment the storage device is manufactured by steps comprising: molding, stamping, blow molding, cutting, forging, welding, gluing, shrink forming, embossing, mechanical etching, casting.

In another embodiment the upper portion comprises at least one hinged cover for covering a receptacle and or a switch.

In another embodiment the surface of at least the upper portion and the lower portion comprises an ornamental surface, wherein the ornamental surface is selected from at least one of: embossing, stamping, etching, painting, coating, electro-plating or anodizing.

In another embodiment the storage device conforms to standards established by at least one of: National Electrical Manufacturers Association (NEMA); International Electrotechnical Commission (IEC); American National Standards Institute (ANSI); Council for Harmonization of Electrotechnical Standardization of the Nations of the Americas (CANENA).

### BRIEF DESCRIPTION OF THE DRAWINGS

A detailed description of the preferred embodiments are provided below with reference to the following drawings:

FIG. 1, is a perspective view, illustrating a switch plate utility hanger for keys, blow dryer and curling irons having a lower portion as a lower protective portion in accordance with an embodiment of the present invention.

FIG. 2, is a perspective view, illustrating a GFI plate utility hanger for keys, blow dryer and curling irons having a lower portion as a lower protective portion in accordance with an embodiment of the present invention.

FIGS. 3-13 are perspective views, illustrating embodiments of a GFI plate utility hanger in accordance with embodiments of the present invention

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE PREFERRED EMBODIMENT

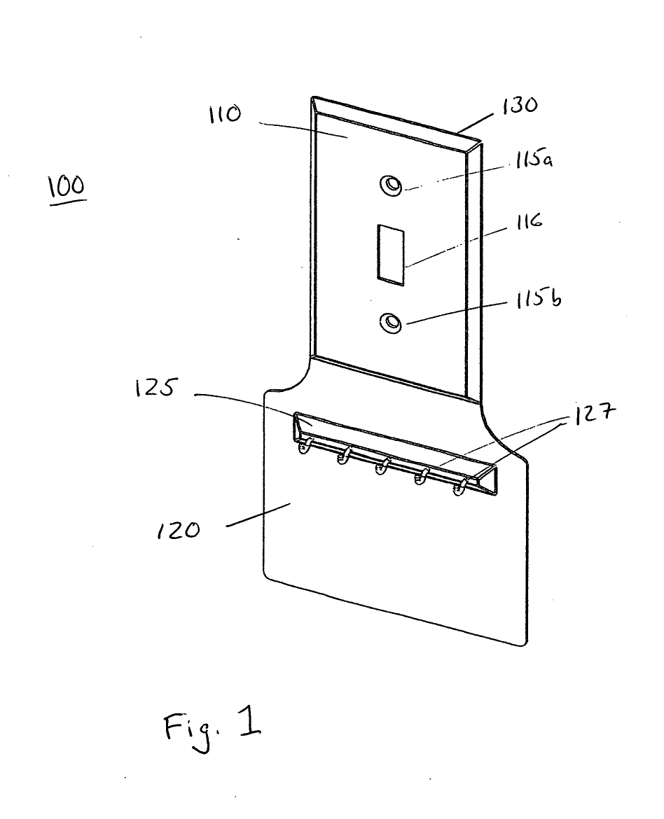

FIG. 1, is a perspective view, illustrating a switch plate utility hanger 100 for keys, blow dryer and curling irons and other appliances or items (not illustrated), having a lower portion 110 as a lower protective portion in accordance with an embodiment of the present invention.

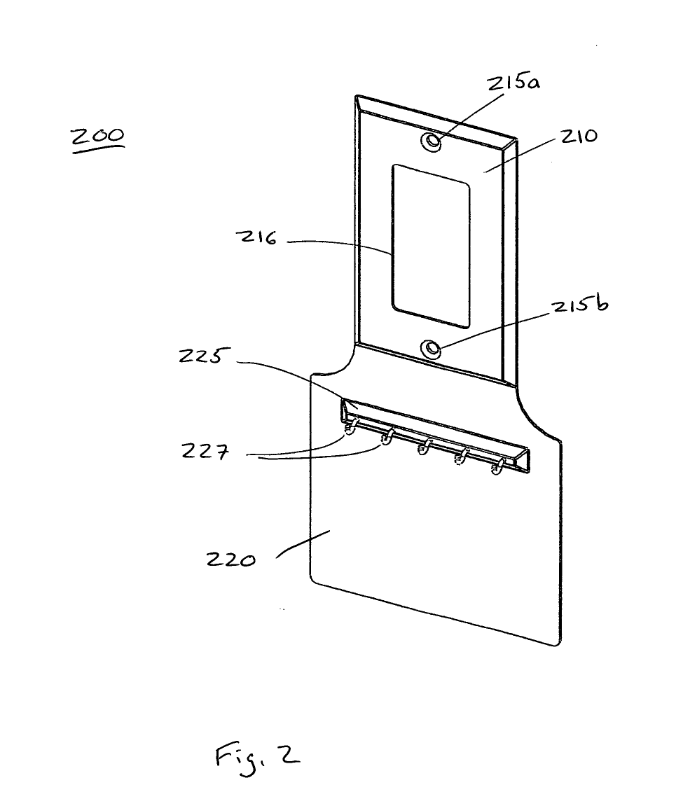

FIG. 2, is a perspective view, illustrating a GFI plate utility hanger 200 for keys, blow dryers, curling irons and other appliances and items (not illustrated) having a lower portion as a lower protective portion in accordance with an embodiment of the present invention.

In one embodiment the instant invention comprises a storage device applied as a cover plate 100, 200, comprising an upper portion (110, 210) capable of being affixed to a junction box (not illustrated) installed to a wall or vertical surface which is typically affixed to the studs supporting the wall surface, such as drywall or paneling. The wall surface may further be covered with wall paper or tile. The upper portion 110, 220 comprising at least one cover plate 100, 200. The cover plate having at least one affixing aperture 115, 115a, 115b, 215, 215a, 215b for accepting a fastener, typically a screw for fastening to the junction box. The upper portion is capable of hosting an utility aperture 116, 216 wherein the utility aperture is capable of accepting a toggle switch arm (illustrated, FIG. 1), GFCI outlet (illustrated, FIG. 2), 15A outlet, 20A, 110V outlet, 220V outlet, 12V outlet, rocker switch, dimmer switch, co-ax outlet, Ether-net outlet, telephone outlet, the gang upper portion comprises at least one aperture.

A lower portion 120, 220 is integrally formed with the upper portion, being significantly weight balanced with respect to the fastener means 115, 215 of the upper portion 110, 210 so as to impose no net torque upon the fastener means when the upper portion 110, 210 is affixed to the junction box. The lower portion 120, 220 further comprising a storage means 125, 225 for storage of an item. Items imagined by the invention include but are not limited to hair dryers, blow dryers, curling irons, hair irons, electric razors, electric clippers, hair brushes, combs, or any other appliance which may be associated with the outlet or switch which is being covered by the cover plate 100, 200. Other appliances include power tools, gardening tools, and powered devices and re-chargeable items.

The lower portion 120, 220 protects a wall surface from contact with the stored item, thus suppressing damage by the stored item by the hooks or pegs 127, 227. The upper portion 110, 210 and the lower portion 120, 220 are of monolithic construction. The monolithic construction being selected of primarily recycled materials and/or recyclable materials.

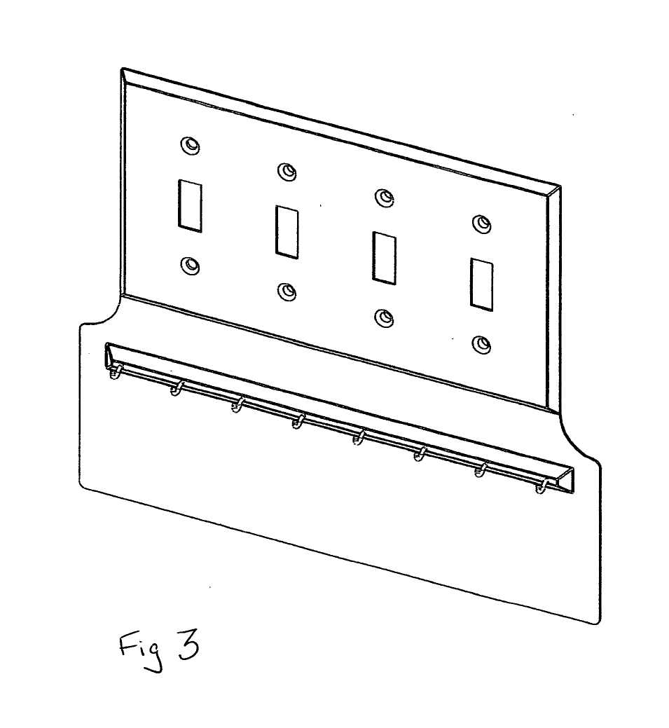

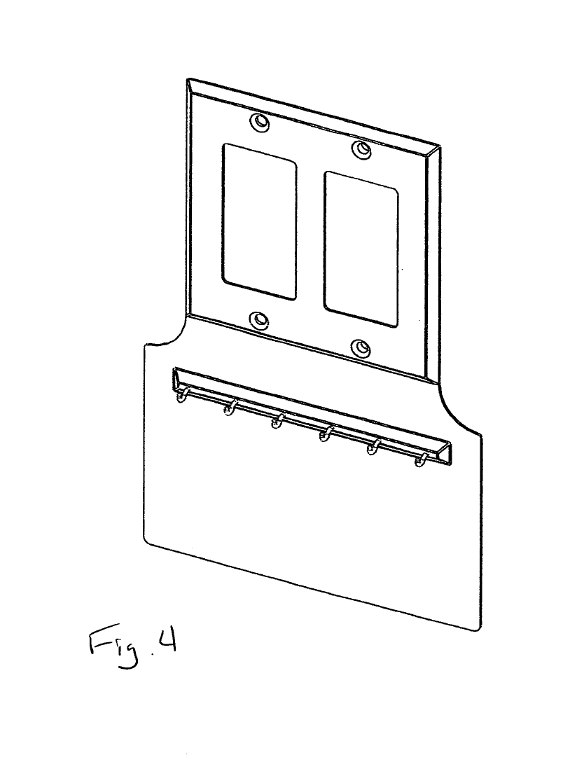

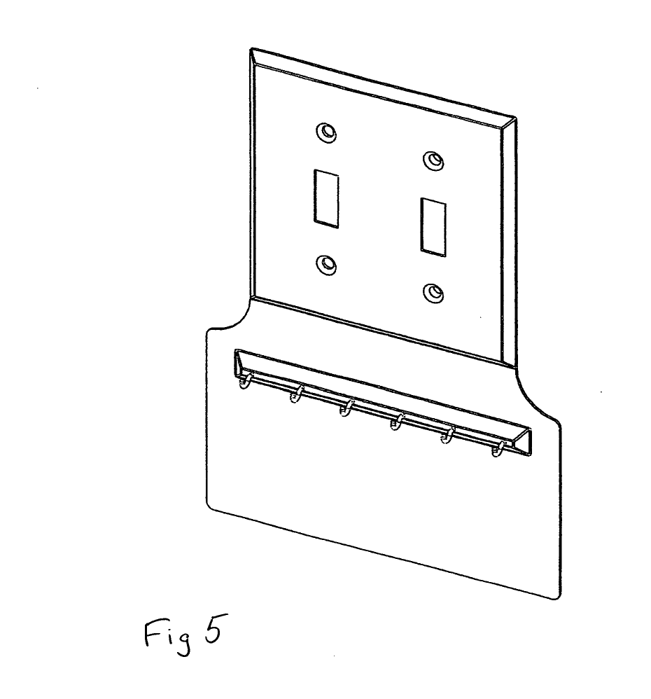

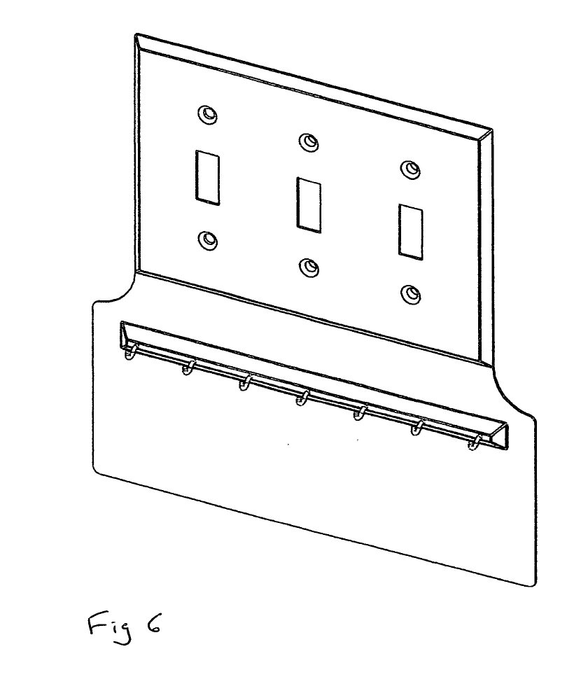

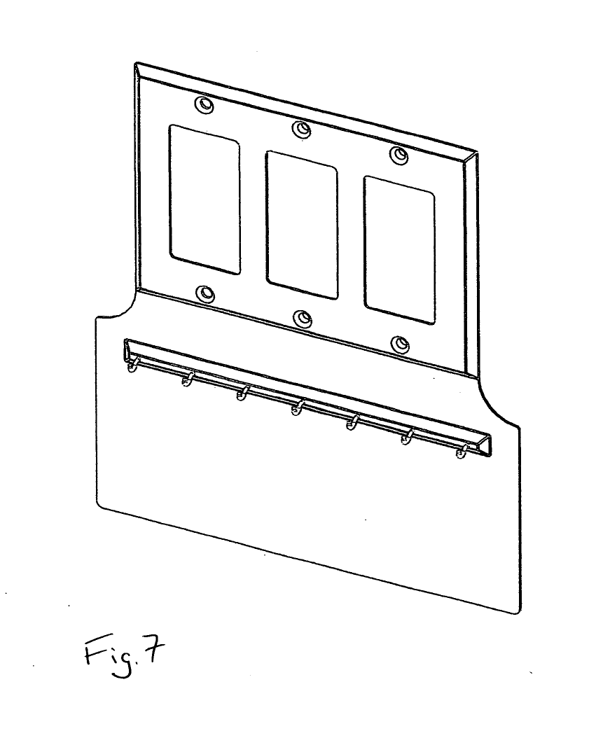

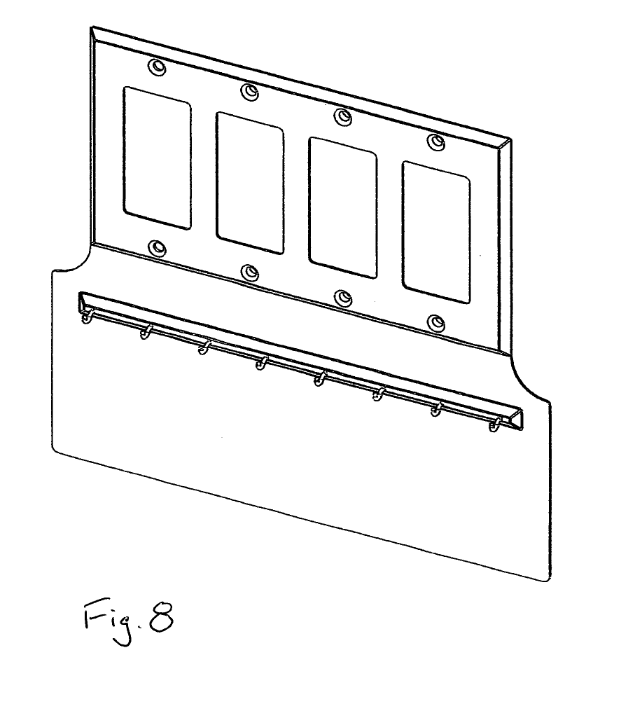

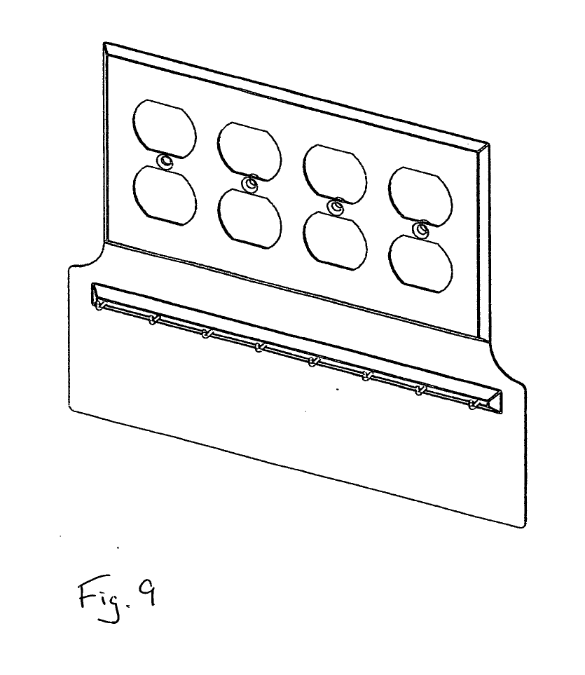

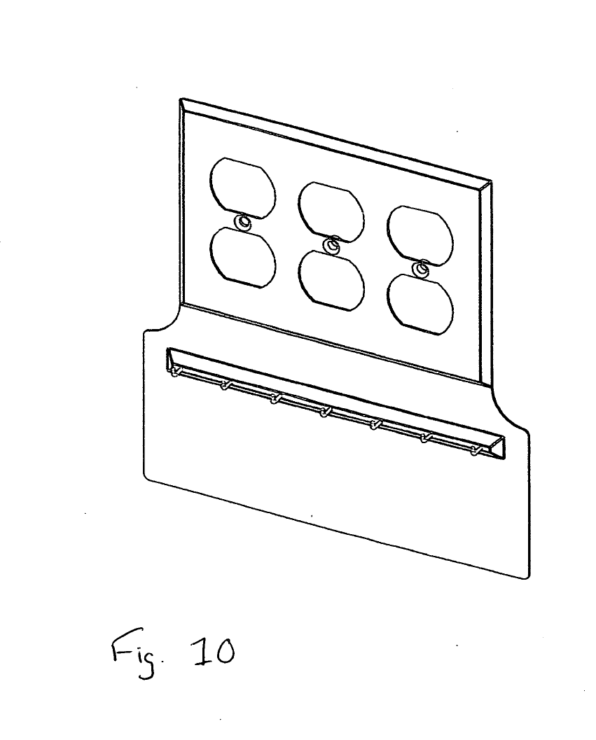

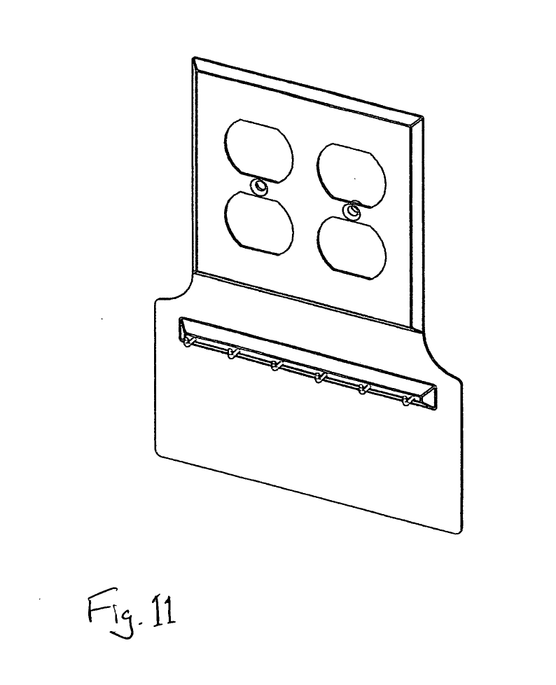

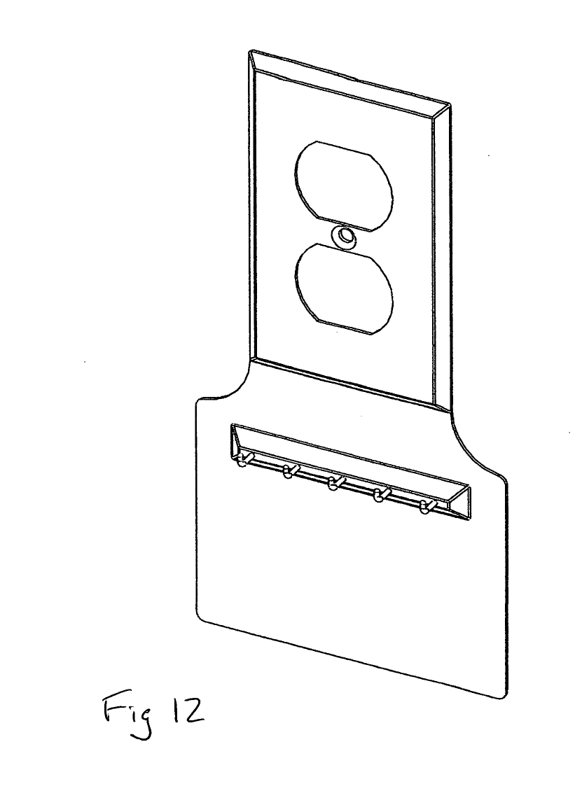

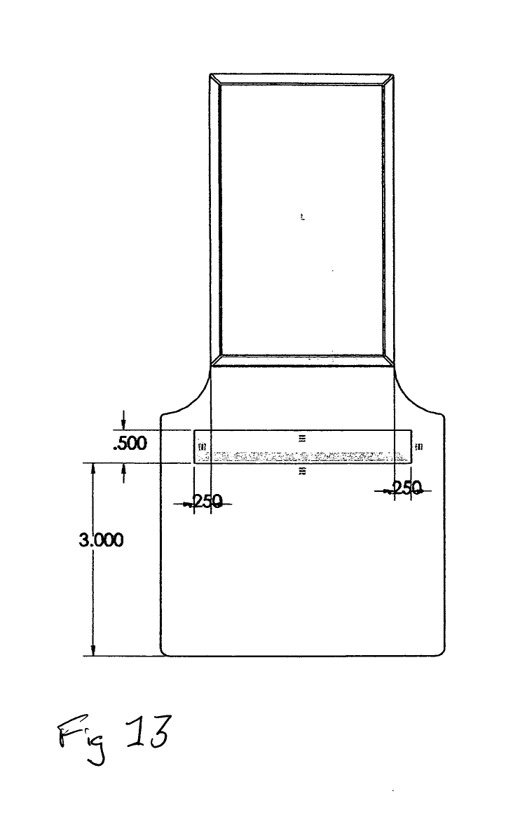

In another embodiment the storage device applied as a cover plate 100, 200 has an upper portion 110, 210 in the form of two or more cover areas 130, 230 each for significantly covering at least one bay of the junction box comprising at least a single gang module and a multiple gang module. A single gang unit is illustrated in FIGS. 1 and 2. Double, triple and multiple gang junction boxes are common, the upper portion 110, 210 comprise multiple cover areas 130, 230 for covering a ganged junction box, such as illustrated in FIG. 3-13.

In another embodiment the lower portion 120, 220 is significantly as wide as the upper portion 110, 210 or significantly wider to facilitate protection of the wall surface from items stored on the hooks/pegs 127, 227.

In another embodiment the upper portion 110, 210, comprises at least one cover area 130, 210 for accepting at least one of: a toggle switch arm of a switch installed within a gang of the junction box (as illustrated in FIG. 1); a single power outlet installed within a gang of the junction box, a double power outlet installed within a gang of the junction box; a duplex power outlet installed within a gang of the junction box, a double power outlet installed within a gang of the junction box; a GFI power outlet installed within a gang of the junction box (as illustrated in FIG. 2), a double power outlet installed within a gang of the junction box; a blank cover; a dimmer switch rheostat arm installed within a gang of the junction box; a coaxial outlet installed within a gang of the junction box; a telephone jack array installed within a gang of the junction box; a split audio/video outlet installed within a gang of the junction box; an Ethernet outlet installed within a gang of the junction box; and or a deco switch installed within a gang of the junction box. It is further contemplated that the outlet element embodiments further include a hinged cover, for protection from weather and compliance to exterior building standards.

In another embodiment the upper portion 110, 210 comprising at least two of the cover areas 130, 230 so as to significantly cover a multiple gang junction box.

In another embodiment the invention 100, 200 is constructed of recycled material and the recyclable material is selected from: virgin materials, metals, alloys, steel, stainless steel, brass, bronze, copper, aluminum, nickel, zinc, pewter, platinum, gold, gold plate, plastics, plastic materials, polycarbonate, resin, epoxy, nylon, polyethylene, high-density polyethylene (HDPE), low-density polyethylene (LDPE), medium density polyethylene (MOPE), linear low-density polyethylene (LLDPE), polyethylene terephthalate (PET), ppolyvinyl chloride (PVD) vinyl, PET types: Polyethylene Terephthalate (PET, PETE), Ultra-high-molecular-weight polyethylene (UHMWP), High Density Polyethylene (HDPE), Polyvinyl Chloride (PVC), Low Density Polyethylene (LDPE), Polypropylene (PP), Polystyrene (PS), polycarbonate or ABS, other plastics, any other recycled or recyclable polymer. Wherein the material selected is at least 10%, 30%, 40%, 50%, 60%, 70%, 80%, 90% and 100% recyclable.

In another embodiment the lower portion 120, 220 comprising a storage means 125, 225 for storage of item. Items imagined by the invention include but are not limited to hair dryers, blow dryers, curling irons, hair irons, electric razors, electric clippers, hair brushes, combs, or any other appliance which may be associated with the outlet or switch which is being covered by the cover plate 100, 200. Other appliances include power tools, gardening tools, and powered devices and re-chargeable items. The storage means 125, 225 comprises at least one array of hooks or pegs 127, 227; wherein the array is significantly centered with respect to the averaged location of the at least one affixing aperture 115, 215 for accepting the fastener, such as a screw (not illustrated) for fastening to the junction box, so as to impose no net torque on the fastener or fasteners when the hooks or pegs 127/227 are loaded.

Another embodiment of the cover plate 100, 200 is manufactured with recycled materials and it is further contemplated that the cover plate 100, 200 is later recycled.

Another embodiment the storage device 100, 200 is manufactured by steps comprising: molding, stamping, blow molding, cutting, forging, welding, gluing, shrink forming, embossing, mechanical etching, casting.

In another embodiment the upper portion 110, 210 comprises at least one hinged cover for covering a receptacle or switch.

In another embodiment the surface of at least the upper portion 110, 210 and the lower portion 120, 220 comprises an ornamental surface, wherein the ornamental surface is selected from at least one of: embossing, stamping, etching, painting, coating, electro-plating or anodizing.

In another embodiment the storage device 100, 200 conforms to standards established by at least one of: National Electrical Manufacturers Association (NEMA); International Electrotechnical Commission (IEC); American National Standards Institute (ANSI); Council for Harmonization of Electrotechnical Standardization of the Nations of the Americas (CANENA).

It is understood that the invention as described herein could be manufactured by several methods and, in particular, it is noted that the storage devices of the present invention may be manufactured by injection molding.

The utility aperture 116, 216 comprises an aperture for accepting a switch arm, GFCI outlet, 15A outlet, 20A, 110V outlet, 220V outlet, 12V outlet, rocker switch, dimmer switch, co-ax outlet, Ether-net outlet, telephone outlet. The at least one gang upper portion comprises at least one utility aperture 116, 216.

Wherein the upper portion 110, 210 and the lower portion 120, 220 lie substantially in the same planer volume.

Other variations and modifications of the invention are possible. All such modifications or variations are believed to be within the sphere and scope of the invention.

1. (canceled)

2. (canceled)

3. (canceled)

4. (canceled)

5. (canceled)

6. (canceled)

7. (canceled)

8. (canceled)

9. A storage device applied as a cover plate, comprising
an upper portion capable of being affixed to a junction box, the upper portion comprising at least one cover plate; the at least one cover plate having at least one affixing aperture for accepting a fastener for fastening to the junction box; wherein the upper portion is capable of hosting an utility aperture;
a lower portion, integrally formed with the upper portion, being significantly weight balanced with respect to the fastener means of the upper portion so as to impose no net torque upon the fastener means when the upper portion is affixed to the junction box;
the lower portion further comprising a storage means for storage of an item;
the lower portion protecting a wall surface from the stored item;
the upper portion and the lower portion being of monolithic construction;
the monolithic construction being formed of primarily recycled materials and/or recyclable materials.

10. The storage device applied as a cover plate of claim 9, wherein the upper portion comprises at two or more cover areas each for significantly covering at least one bay of the junction box comprising at least one of a single gang module and a multiple gang module.

11. The storage device applied as a cover plate of claim 9, wherein the lower portion is significantly as wide as the upper portion or significantly wider.

12. The storage device applied as a cover plate of claim 9, wherein the upper portion comprises at least one cover area and capable of hosting an utility aperture; for accepting at least one of a toggle switch arm of a switch installed within a gang of the junction box; a single power outlet installed within a gang of the junction box, a double power outlet installed within a gang of the junction box; a duplex power outlet installed within a gang of the junction box, a double power outlet installed within a gang of the junction box; a GFI power outlet installed within a gang of the junction box, a double power outlet installed within a gang of the junction box; a blank cover; a dimmer switch rheostat arm installed within a gang of the junction box; a coaxial outlet installed within a gang of the junction box; a telephone jack array installed within a gang of the junction box; a split audio/video outlet installed within a gang of the junction box; an Ethernet outlet installed within a gang of the junction box; a deco switch installed within a gang of the junction box.

13. The storage device applied as a cover plate of claim 12, wherein the upper portion comprises at least two of the cover areas as claimed in claim 12, so as to significantly cover a multiple gang junction box.

14. The storage device applied as a cover plate of claim 9, wherein the recycled material and the recyclable material is selected from: virgin materials, metals, alloys, steel, stainless steel, brass, bronze, copper, aluminum, nickel, zinc, pewter, platinum, gold, gold plate, plastics, plastic materials, polycarbonate, resin, epoxy, nylon, polyethylene, high-density polyethylene (HDPE), low-density polyethylene (LDPE), medium density polyethylene (MDPE), linear low-density polyethylene (LLDPE), polyethylene terephthalate (PET), ppolyvinyl chloride (PVD) vinyl, PET types: Polyethylene Terephthalate (PET, PETE), Ultra-high-molecular-weight polyethylene (UHMWP), High Density Polyethylene (HDPE), Polyvinyl Chloride (PVC), Low Density Polyethylene (LDPE), Polypropylene (PP), Polystyrene (PS), polycarbonate or ABS, other plastics, any other recycled or recyclable polymer.

15. The storage device applied as a cover plate of claim 9, having the lower portion comprising the storage
means for storage of the item; wherein the storage means comprises at least one array of hooks or pegs;
wherein the array is significantly centered with respect to the averaged location of the at least one affixing aperture for accepting the fastener for fastening to the junction box, so as to impose no net torque on the fastener or fasteners.

16. The storage device applied as a cover plate of claim 9, wherein the cover plate is manufactured with recycled materials and wherein the cover plate is later recycled.

17. The storage device applied as a cover plate of claim 9, wherein the storage device is manufactured by steps comprising: molding, stamping, blow molding, cutting, forging, welding, gluing, shrink forming, embossing, mechanical etching, casting.

18. The storage device applied as a cover plate of claim 12, wherein the upper portion comprises at least one hinged cover for covering a receptacle, and/or a switch.

19. The storage device applied as a cover plate of claim 9, wherein the surface of at least the upper portion and the lower portion comprises an ornamental surface, wherein the ornamental surface is selected from at least one of: embossing, stamping, etching, painting, coating, electro-plating or anodizing.

20. The storage device applied as a cover plate of claim 9, wherein the storage device conforms to standards established by at least one of: National Electrical Manufacturers Association (NEMA);
International Electrotechnical Commission (IEC); American National Standards Institute (ANSI);
Council for Harmonization of Electrotechnical Standardization of the Nations of the Americas (CANENA).
